(19) United States
(12) Patent Application Publication
(10) Pub. No.: US 2009/0164305 A1
(43) Pub. Date: Jun. 25, 2009

(54) SYSTEM AND METHOD FOR MANAGING PRODUCT QUALITY

(75) Inventors: CHI-CHIH WANG, Tu-Cheng (TW); BING-YU HE, Shenzhen City (CN); YONG-HUA SONG, Shenzhen City (CN); JIE XU, Shenzhen City (CN); YA-QUAN LI, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRCISION INDUSTRY (ShenZhen) Co., LTD., Shenzhen City (CN); HON HAI PRECISION INDUSTRY CO., LTD., Tu-Cheng (TW)

(21) Appl. No.: 12/249,974

(22) Filed: Oct. 13, 2008

(30) Foreign Application Priority Data
Dec. 21, 2007 (CN) 200710203307.1

(51) Int. Cl. G06Q 10/00; G06F 19/00; G06Q 30/00

(52) U.S. Cl. 705/10; 700/110; 700/107; 705/28; 705/7

(57) ABSTRACT

A computer-implemented method for managing product quality is disclosed. The method integrates various inspections on quality of materials and products from purchasing the materials until delivering the products to customers. A related system is also disclosed. By utilizing the method and the related system, multiple inspection results are recorded.

### BACKGROUND

1. Field of the Invention

Embodiments of the present disclosure relate to quality control systems and methods, and more particularly to a system and method for managing product quality.

2. Description of related art

Various quality information systems are employed in manufacturing plants to maintain product quality. Quality control/inspection may be held or stored according to different procedures through purchasing materials from a supplier until delivering products to customers, such as a quality inspection of materials, a quality inspection of products, a quality inspection of packed products, etc. Inspection results are recorded in each of the procedures. However, it is difficult for analyzing and managing the inspection results of the quality of the materials and the products recorded in different procedures.

What is needed, therefore, is an improved system and method for managing product quality to overcome the above-stated problems and facilitate track the quality control/inspection of the materials and the products in different procedures.

### SUMMARY

A system for managing product quality is provided. The system includes an incoming quality control module, a material quality control module, an in-process quality control module, a spot-checking module, a shipment management module, and an out-going quality control module. The incoming quality control module is configured for recording first inspection results of a quality inspection of materials imported from a supplier, and recording warehouse data of qualified materials according to the first inspection results after the qualified materials are warehoused into a stock. The material quality control module is configured for generating a picking list for picking materials from the stock, recording second inspection results of a quality inspection of the picked materials, and determining to put qualified picked materials into production. The in-process quality control module is configured for recording third inspection results of a quality inspection of products. The spot-checking module is configured for recording checking results of a spot check of qualified products according to the third inspection results, and determining if the qualified products pass the spot check. The shipment management module is configured for determining that the qualified products which have passed the spot check are ready to be packed, and recording warehouse data of packed products after the qualified products are packed. The out-going quality control module is configured for recording fourth inspection results of a quality inspection of the packed products, and determining to deliver the qualified packed products to customers according to the fourth inspection results.

Other advantages and novel features of the present disclosure will be drawn from the following detailed description of certain inventive embodiments of the present disclosure with reference to the attached drawings.

### BRIEF DESCRIPTION OF THE DRAWINGS

FIG. 1 is a block diagram of one embodiment of a system for managing product quality.

FIG. 2 is a flowchart of one embodiment of a method for managing product quality.

### DETAILED DESCRIPTION OF CERTAIN INVENTIVE EMBODIMENTS

All of the processes described below may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

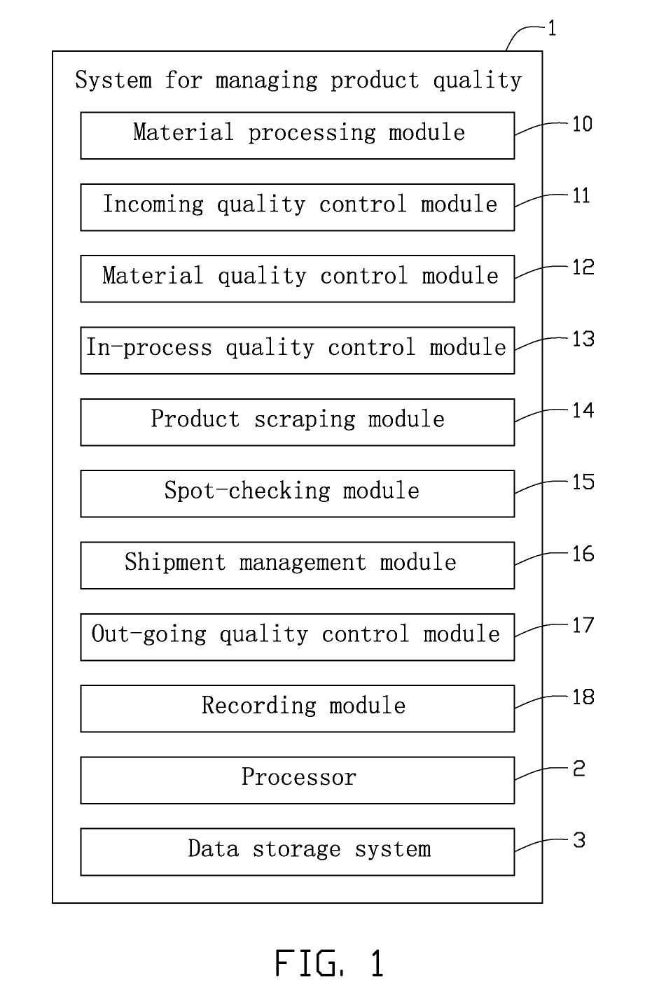

FIG. 1 is a block diagram of one embodiment of a system for managing product quality (hereinafter referred to as “the system 1”). The system 1 is used for integrating various inspections of materials or products in different processes, which may include a materials purchasing process, a production process, a spot-check process, a delivery process, etc. Depending on the embodiment, the system 1 may be a computer, a server (i.e., a host computer) or other kind of electronic devices.

In one embodiment, the system 1 may comprise a material processing module 10, an incoming quality control (IQC) module 11, a material quality control module 12, an in-process quality control (IPQC) module 13, a product scraping module 14, a spot-checking module 15, a shipment management module 16, an out-going quality control (OQC) module 17, and a recording module 18. The system 1 may further comprise at least one processor 2, and a data storage system 3. The modules 10-18 may be used to perform one or more operations for the system 1. Additionally, the system 1 may comprise one or more specialized or general purpose processors, such as the at least one processor 2 for executing at least one operation for the modules 10-18.

The material processing module 10 is configured for generating a check list for each type of materials when the materials are imported from a supplier. The check list may include, but not limited to, a check list number, material numbers, material names, types, information of a supplier provided the materials, imported time of the materials, and so on.

The incoming quality control module 11 is configured for recording first inspection results of a quality inspection of the materials, and recording warehouse data of qualified materials according to the first inspection results after the qualified materials are warehoused into a stock. The quality inspection of the materials include inspecting appearances of the materials and inspecting material dimensions, and so on. If the materials are determined to be qualified, then the qualified materials are warehoused into the stock; otherwise, if unqualified materials are returned to the supplier, the incoming quality control module 11 generates requisition information of the unqualified materials, and sends the requisition information to the supplier for replacing the unqualified materials with the qualified materials.

The material quality control module 12 is configured for generating a picking list for picking the materials from the stock, and recording second inspection results of a quality inspection of the picked materials. Upon the quality inspection of the picked materials, qualified picked materials are put into production, unqualified picked materials are returned to the stock, and information of the unqualified picked materials are recorded by the material quality control module 12.

The in-process quality control module 13 is configured for recording third inspection results of a quality inspection of products, which are produced by the qualified picked materials. The quality inspection of products may include, but not limited to, inspecting if the quality of the products are qualified, and if the material numbers have been changed during the production. The products may be semi finished products or finished products, and the semi finished products are put into next production if passed the quality inspection.

The product scraping module 14 is configured for determining to scrap unqualified products, and recording the scrapped information of the unqualified products, which includes names, amounts and material numbers of the scrapped unqualified products.

The spot-checking module 15 is configured for recording checking results of a spot check of qualified products according to the third inspection results, and determining if the qualified products pass the spot check. Inspection projects of the spot check may be substantial the same as the inspection of the produces, or be newly added or canceled based on the inspection of the products. The spot-checking module 15 is further configured for presetting a qualified standard for a same batch of products. For example, the qualified standard may be preset as 95%, if a qualified rate of the spot check of the qualified products is not less than 95%, the batch of the qualified products are determined to pass, otherwise, the batch of the qualified products are determined to return to the quality inspection of the products for further inspection or reproduction.

The shipment management module 16 is configured for determining that the qualified products which pass the spot check are ready to be packed, and determining to tag packed products after packing. The shipment management module 16 is further configured for recording warehouse data of the packed products after the qualified products are warehoused in the stock.

The out-going quality control module 17 is configured for recording fourth inspection results of a quality inspection of the packed products before delivering the packed products to customers. The quality inspection of the packed products includes inspecting if the packed products are packed accord with a packing standard, and inspecting if tags of the packed products are proper. If the packed products are determined to be qualified, the qualified packed products are delivered to the customers thereafter; otherwise, if the packed products are determined to be unqualified, the unqualified packed products are returned to be packed or tagged again.

The recording module 18 is configured for recording feedback information from the customers after the qualified packed products are delivered to the customers. The feedback information may be a return requisition for returning the delivered products, the return requisition may include reasons and amounts of products need to be returned.

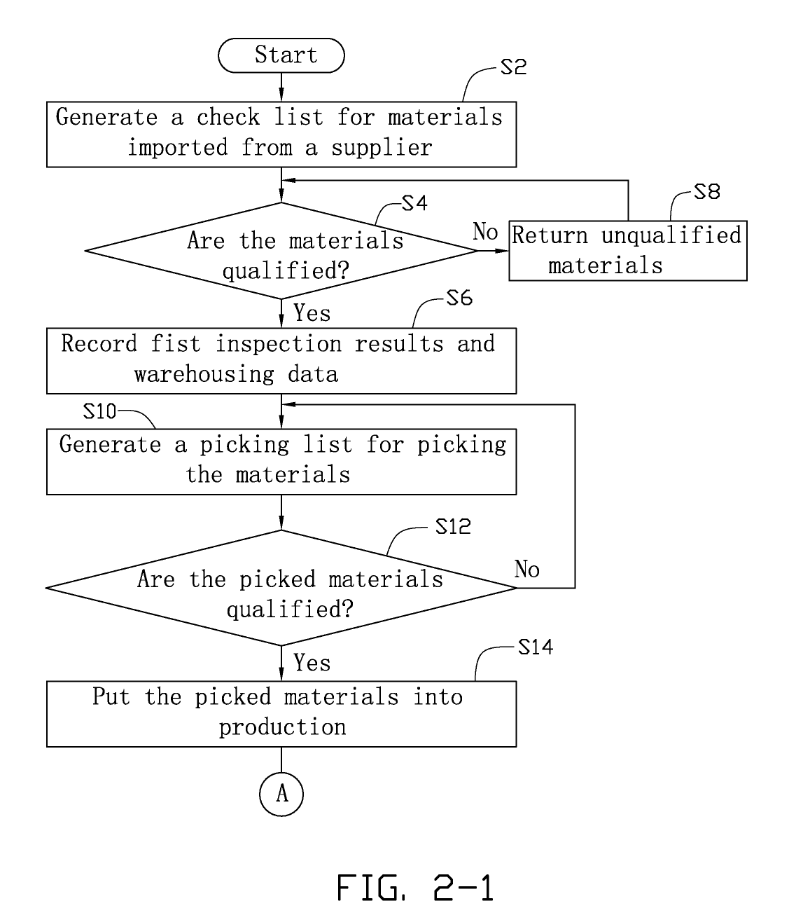

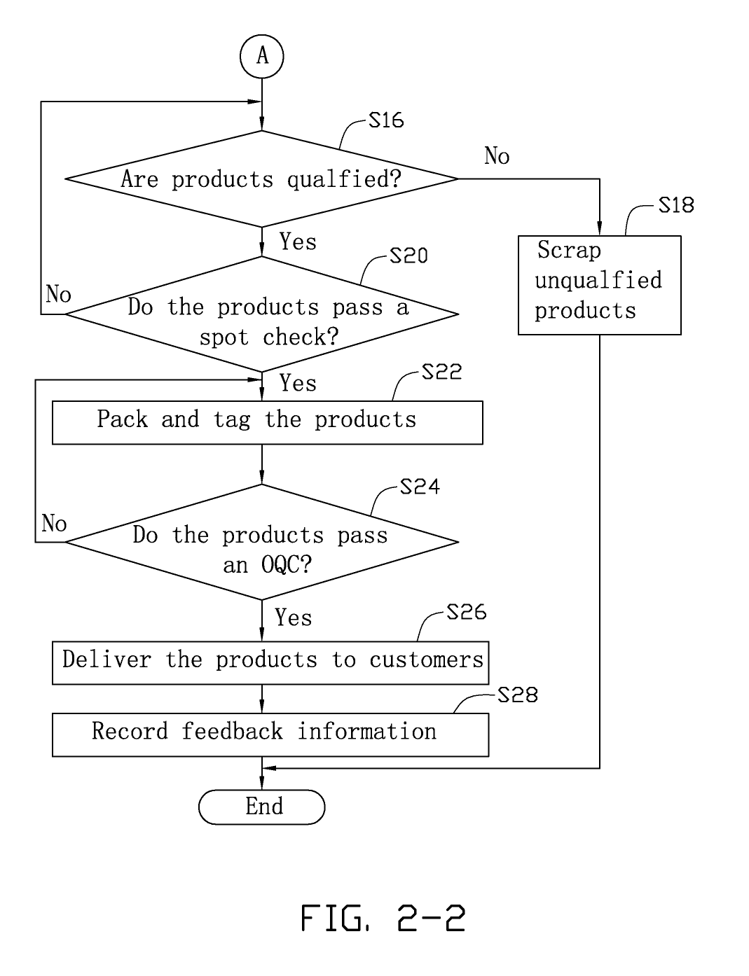

FIG. 2 is a flowchart of one embodiment of a method for managing product quality. Depending on the embodiment, additional blocks may be added, others removed, and the ordering of the blocks may be changed.

In block S2, the material processing module 10 generates a check list for each type of material when one or more materials are imported from the supplier. The check list may include, but is not limited to, a check list number, material numbers, material names, types of the materials, information of the supplier provided the materials, and imported time of the materials.

In block S4, a quality inspection of the materials is implemented for determining if the materials are qualified. If the materials are qualified, in block S6, the incoming quality control module 11 records first inspection results of the quality inspection of the materials, and records warehouse data of qualified materials according to the first inspection results after the qualified materials are warehoused into the stock. Otherwise, if the materials are unqualified, in block S8, the incoming quality control module 11 generates requisition information of the unqualified materials that are returned to the supplier, and sends the requisition information to the supplier for replacing the unqualified materials with the qualified materials.

In block S10, the material quality control module 12 generates a picking list for picking the materials from the stock.

In block S12, a quality inspection of picked materials is implemented for determining if the picked materials are qualified. If the picked materials are qualified, in block S14, the material quality control module 12 records second inspection results of the quality inspection of the picked materials, and qualified picked materials are put into production directly. Otherwise, if the picked materials are unqualified, the procedure returns to the block S10 for regenerating a picking list for picking other materials.

In block S16, a quality inspection of the products is implemented for inspecting if products are qualified. If the products are qualified, in block S20, the in-process quality control module 13 records third inspection results of the quality inspection of products, and a spot check of the qualified products is implemented according to the third inspection results for determining if the qualified products pass the spot check. Otherwise, if the products are unqualified, in block S18,the product scraping module 14 determines to scrap the unqualified products, and records scrapped information of the unqualified products.

If the qualified products pass the spot check, in block S22, the spot-checking module 15 records checking results of a spot check of the qualified products, and the shipment management module 16 determines that the qualified products which pass the spot check are ready to be packed, and tags packed products after packing the products. The shipment management module 16 further records warehouse data of the packed products after the qualified products are warehoused in the stock. If the qualified products do not pass the spot check, the procedure returns to the block S16 for inspecting the products again.

In block S24, a quality inspection of the packed products is implemented for inspecting if the packed products are qualified before delivering the packed products to customers. If the packed products are qualified, in block S26, the out-going quality control module 17 records fourth inspection results of the quality inspection of the packed products, and qualified packed products are delivered to the customers thereafter. Otherwise, if the packed products are unqualified, the procedure is returned to the block S22 for packing the products and tagging the packed products again.

In block S28, the recording module 18 records feedback information from the customers after the qualified packed products are delivered to the customers. The feedback information may be a return requisition for returning the delivered products, and the return requisition may include reasons and amounts of products need to be returned.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for managing product quality, the system comprising:
an incoming quality control module configured for recording first inspection results of a quality inspection of materials imported from a supplier, and recording warehouse data of qualified materials according to the first inspection results after the qualified materials are warehoused into a stock;
a material quality control module configured for generating a picking list for picking materials from the stock, recording second inspection results of a quality inspection of the picked materials, and determining to put qualified picked materials into production;
an in-process quality control module configured for recording third inspection results of a quality inspection of products;
a spot-checking module configured for recording checking results of a spot check of qualified products according to the third inspection results, and determining if the qualified products pass the spot check;
a shipment management module configured for determining that the qualified products which have passed the spot check are ready to be packed, and recording warehouse data of packed products after the qualified products are packed;
an out-going quality control module configured for recording fourth inspection results of a quality inspection of the packed products, and determining to deliver the qualified packed products to customers according to the fourth inspection results; and
at least one processor for executing the material processing module, the incoming quality control module, the material quality control module, the in-process quality control module, the spot-checking module, the shipment management module, and the out-going quality control module.

2. The system according to claim 1, further comprising a material processing module configured for generating a check list for each type of the materials imported from the supplier.

3. The system according to claim 1, further comprising a product scraping module configured for determining to scrap unqualified products, and recording the scrapped information of the unqualified products.

4. The system according to claim 1, further comprising a recording module configured for recording feedback information from the customers after the qualified packed products are delivered to the customers.

5. The system according to claim 1, wherein the incoming quality control module is further configured for generating requisition information of unqualified materials that are returned to the supplier, and sending the requisition information to the supplier for replacing the unqualified materials with the qualified materials.

6. A computer-implemented method for managing product quality, the method comprising:
recording first inspection results of a quality inspection of materials imported from a supplier;
recording warehouse data of qualified materials according to the first inspection results after the qualified materials are warehoused into a stock;
generating a picking list for picking materials from the stock;
recording second inspection results of a quality inspection of the picked materials, and determining to put qualified picked materials into production thereafter;
recording third inspection results of a quality inspection of products, recording checking results of a spot-check of qualified products according to the third inspection results, and determining if the qualified products pass the spot-check;
determining that the qualified products which have passed the spot check are ready to be packed, and recording warehouse data of packed products after the qualified products are packed; and
recording fourth inspection results of a quality inspection of the packed products, and determining to deliver qualified packed products to customers according to the fourth inspection results.

7. The method according to claim 6, further comprising:
generating a check list for each type of the materials imported from a supplier before the step of recording first inspection results of a quality inspection of materials imported from a supplier.

8. The method according to claim 6, wherein the step of recording third inspection results of a quality inspection of products comprises:
determining to scrap unqualified products; and
recording the scrapped information of the unqualified products, the scrapped information comprising product names, amounts and part numbers of the unqualified products.

9. The method according to claim 6, further comprising:
recording feedback information from the customers after the qualified packed products are delivered to the customers.

10. The method according to claim 6, further comprising:
generating requisition information of unqualified materials that are returned to the supplier, and sending the requisition information to the supplier for replacing the unqualified materials with the qualified materials, before the step of recording first inspection results of a quality inspection of materials imported from a supplier.

11. A computer-readable medium having stored thereon instructions that, when executed by a computer, causing the computer to perform a method for managing product quality, the method comprising:
recording first inspection results of a quality inspection of materials imported from a supplier;
recording warehouse data of qualified materials according to the first inspection results after the qualified materials are warehoused into a stock;
generating a picking list for picking materials from the stock;
recording second inspection results of a quality inspection of the picked materials, and determining to put qualified picked materials into production thereafter;
recording third inspection results of a quality inspection of products, recording checking results of a spot-check of qualified products according to the third inspection results, and determining if the qualified products pass the spot-check;
determining that the qualified products which have passed the spot check are ready to be packed, and recording warehouse data of packed products after the qualified products are packed; and
recording fourth inspection results of a quality inspection of the packed products, and determining to deliver qualified packed products to customers according to the fourth inspection results.

12. The medium according to claim 11, wherein the method further comprising:
generating requisition information of unqualified materials that are returned to the supplier, and sending the requisition information to the supplier for replacing the unqualified materials with the qualified materials, before the step of recording first inspection results of a quality inspection of materials imported from a supplier.

13. The medium according to claim 11, wherein the step of recording third inspection results of a quality inspection of products comprises:
determining to scrap unqualified products; and
recording the scrapped information of the unqualified products, the scrapped information comprising product names, amounts and part numbers of the unqualified products.

14. The medium according to claim 11, wherein the method further comprising:
recording feedback information from the customers after the qualified packed products are delivered to the customers.
